(19) United States
(12) Patent Application Publication
(10) Pub. No.: US 2026/0365523 A1
(43) Pub. Date: Nov. 19, 2026

(54) SYSTEMS AND METHODS FOR ALIGNING DEFECTS IN A CRYSTAL

(71) Applicant: Purdue Research Foundation, West Lafayette, IN (US)

(72) Inventor: Farid Kalhor, Lafayette, IN (US)

(73) Assignee: Purdue Research Foundation, West Lafayette, IN (US)

(21) Appl. No.: 18/612,491

(22) Filed: Mar. 21, 2024

Related U.S. Application Data
(60) Provisional application No. 63/454,135, filed on Mar. 23, 2023.

(51) Int. Cl. C01B 32/28

(52) U.S. Cl. CPC C01B 32/28

(57) ABSTRACT

A method for aligning atomic defects in a crystal includes positioning the crystal within a vacuum chamber, positioning a pair of electrodes adjacent to the crystal, decreasing an internal pressure within the vacuum chamber from an ambient pressure to a desired pressure, increasing an internal temperature within the vacuum chamber from an ambient temperature to a desired temperature, activating an electric field within the vacuum chamber between the pair of electrodes, and deactivating the electric field.

### CROSS-REFERENCE TO RELATED APPLICATIONS

This application is related to and claims the priority benefit of U.S. Provisional Patent Application No. 63/454,135, entitled “Systems and Methods for Aligning Defects in a Crystal,” filed Mar. 23, 2023, the contents of which are hereby incorporated by reference in their entirety into the present disclosure.

### TECHNICAL FIELD

The present application relates to quantum science and technology and precision test materials, and particularly to a system and method for preparing a nitrogen-vacancy center in diamond.

### BACKGROUND

NV (nitrogen-vacancy) centers are defects in the diamond crystal that have many potential applications due to their unique properties, which make them useful for various fields, including quantum computing, sensing, and biophysics. In quantum computing, NV center diamonds are used as qubits, the basic unit of quantum information, due to their long coherence time and ability to operate at room temperature. They can be used for quantum information processing, such as quantum communication and cryptography. NV center diamonds are also used in sensing applications, including the detection of magnetic fields, temperature, and pressure. The unique property of NV centers is that their fluorescence is sensitive to magnetic fields, allowing for the measurement of magnetic fields with high sensitivity and spatial resolution. This makes them useful for applications such as magnetometry, which has potential uses in the fields of geology, biology, and material science. In biophysics, NV center diamonds have potential applications for biological sensing and imaging. They can be used as nanoscale probes for imaging and monitoring biological systems, including the detection of single molecules, pH sensing, and temperature sensing.

Various methods exist for creating such crystals having functional defects, and specifically for aligning those defects. One such method is plasma-enhanced chemical vapor deposition (PECVD). PECVD is a thin-film deposition technique which involves using a plasma to deposit thin films of material onto a substrate. Specifically, in PECVD a gas is introduced into a vacuum chamber and is ionized by an electric field to form a plasma. The plasma then breaks down the gas into reactive species such as radicals and ions, which react with a substrate surface to form a thin film. The plasma also provides energy to the gas, which can facilitate the reaction and improve film quality. PECVD has certain advantages over other thin-film deposition techniques. First, it can deposit films at low temperatures, which can be important for applications involving temperature-sensitive substrates. Additionally, the use of a plasma can provide more control over film properties such as composition, morphology, and thickness. PECVD can also deposit films with a wide range of materials, including silicon, carbon, and metal oxides. PECVD is used in a variety of applications, including the deposition of thin films for microelectronics and optics, such as anti-reflective coatings and passivation layers. PECVD can generate aligned NV centers if the substrate has a specific growth plain (e.g., a (111) plain for diamond). The defects form in the crystal during the process. The density of the defects can be controlled with adding impurities to the precursors; however, the direction of the defects cannot be controlled.

An alternative technique is annealing diamond in a vacuum chamber. This technique uses a vacuum chamber and increases the temperature of a diamond substrate to turn nitrogen impurities in the diamond (i.e., impurities that are naturally present or artificially implanted) into NV centers.

However, improvements are still needed for controlling the alignment of defects in existing crystals.

### SUMMARY

Described herein are systems and methods related to aligning defects in a crystal. To that end, some method embodiments can include positioning the crystal within a vacuum chamber, positioning a pair of electrodes adjacent to the crystal, decreasing an internal pressure within the vacuum chamber from an ambient pressure to a desired pressure, increasing an internal temperature within the vacuum chamber from an ambient temperature to a desired temperature, activating an electric field within the vacuum chamber between the pair of electrodes, and deactivating the electric field. In some versions, the positioning of a first electrode of the pair of electrodes relative to a second electrode of the pair of electrodes can define an axis intersecting the first and second electrodes through a portion of the crystal. In some versions, the electric field direction can be parallel to the axis defined by the pair of electrodes.

In some embodiments, the method can include lowering the internal temperature within the vacuum chamber to the ambient temperature upon deactivating the electric field. In other embodiments, the method can include purging the vacuum chamber with a process gas first prior to decreasing the internal pressure within the vacuum chamber from an ambient pressure to a desired pressure.

This summary is provided to introduce a selection of the concepts that are described in further detail in the detailed description and drawings contained herein. This summary is not intended to identify any primary or essential features of the claimed subject matter. Some or all of the described features may be present in the corresponding independent or dependent claims, but should not be construed to be a limitation unless expressly recited in a particular claim. Each embodiment described herein does not necessarily address every object described herein, and each embodiment does not necessarily include each feature described. Other forms, embodiments, objects, advantages, benefits, features, and aspects of the present disclosure will become apparent to one of skill in the art from the detailed description and drawings contained herein. Moreover, the various apparatuses and methods described in this summary section, as well as elsewhere in this application, can be expressed as a large number of different combinations and subcombinations. All such useful, novel, and inventive combinations and subcombinations are contemplated herein, it being recognized that the explicit expression of each of these combinations is unnecessary.

### BRIEF DESCRIPTION OF THE DRAWINGS

While the specification concludes with claims which particularly point out and distinctly claim this technology, it is believed this technology will be better understood from the following description of certain examples taken in conjunction with the accompanying drawings, in which like reference numerals identify the same elements and in which:

FIG. 1 depicts one exemplary system for aligning the atomic defects in a crystal sample; and

FIG. 2 depicts a flowchart representation of one exemplary method for aligning the atomic defects in a crystal sample.

The drawings are not intended to be limiting in any way, and it is contemplated that various embodiments of the technology may be carried out in a variety of other ways, including those not necessarily depicted in the drawings. The accompanying drawings incorporated in and forming a part of the specification illustrate several aspects of the present technology, and together with the description serve to explain the principles of the technology; it being understood, however, that this technology is not limited to the precise arrangements shown, or the precise experimental arrangements used to arrive at the various graphical results shown in the drawings.

### DETAILED DESCRIPTION

The following description of certain examples of the technology should not be used to limit its scope. Other examples, features, aspects, embodiments, and advantages of the technology will become apparent to those skilled in the art from the following description, which is by way of illustration, one of the best modes contemplated for carrying out the technology. As will be realized, the technology described herein is capable of other different and obvious aspects, all without departing from the technology. Accordingly, the drawings and descriptions should be regarded as illustrative in nature and not restrictive.

It is further understood that any one or more of the teachings, expressions, embodiments, examples, etc. described herein may be combined with any one or more of the other teachings, expressions, embodiments, examples, etc. that are described herein. The following-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

The systems and methods described herein can partially or completely align the atomic defects in a crystal, for example, NV centers in diamonds in a particular direction. Aligning the defects within a NV center diamond crystal can have significant advantages. The NV center is a promising candidate for use in various applications, including quantum computing and sensing. However, the performance of an NV center is highly dependent on the crystal's properties. Aligning the defects can enhance the coherence interaction of the NV center, leading to better performance. This improvement can be crucial for applications such as quantum computing, where the reliability of qubits is essential. In addition to improving the performance of NV centers, aligning the defects can also provide consistency in sensor fabrication. When fabricating sensors or qubits involving NV centers, it is crucial to have consistent results across different defect sites. Aligning the defects within a diamond crystal can help ensure that the defects are in the expected direction across all fabricated sensors or qubits. In addition to that, a NV center based sensor with aligned defects is capable of measuring magnetic fields with a higher sensitivity. Another significant advantage of aligning the defects within a diamond crystal is the facilitation of quantum entanglement. In quantum computing applications, it is essential to create entanglement between different qubits. Aligning the defects within a diamond crystal can make it easier to create and maintain entanglement between NV centers, which can be beneficial for quantum computing. Overall, aligning the defects within a nitrogen vacancy center diamond crystal can improve the performance of NV centers and facilitate their use in various applications.

Accordingly, the systems and methods described herein provide the capability of controlling and aligning the defects in an existing crystal. Generally, the method involves applying an electric field to one or multiple of the crystal axes while annealing the crystal. The NV centers in diamonds naturally form along one of the four crystal axes. The electric field therefore lowers the formation energy of the defects in one or more directions which leads to the formation or realigning of the defects along those directions. Finally, the annealing process allows the vacancies or impurities in the crystal to become mobile and accelerates the formation or alignment process.

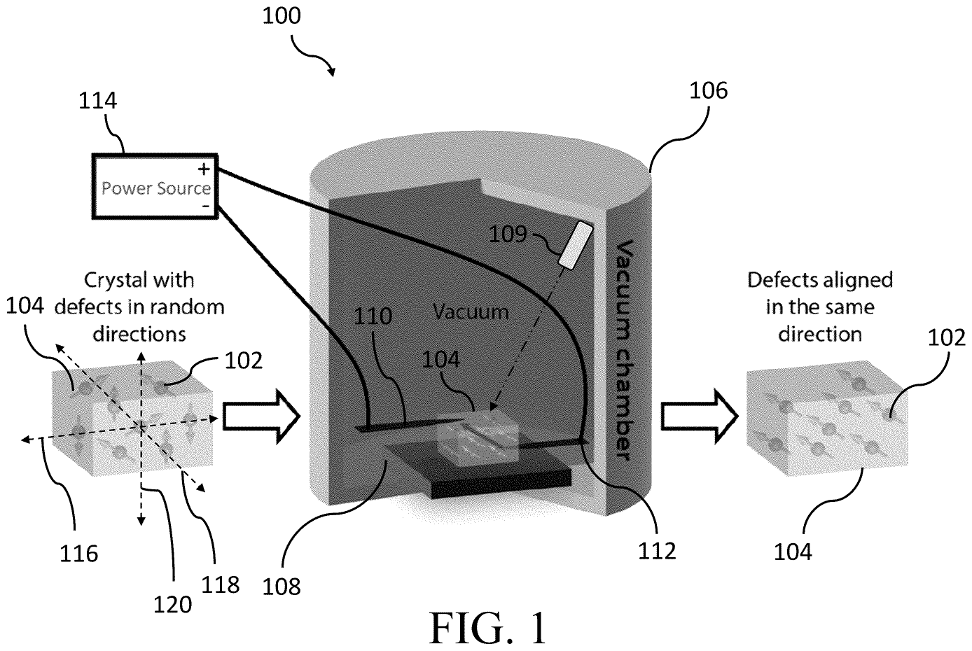

Shown in FIG. 1 is one exemplary system (100) for aligning the defects (102) in a crystal (104). The system (100) includes a vacuum chamber (106), a temperature-controllable heating element such as heating plate (108), electrodes (110, 112), and an electric field generator (114) coupled with the electrodes (110, 112). The heating stage (108) is positioned within the vacuum chamber (106) and configured to hold a crystal sample (104) thereon. The electrodes (110,112) may be coupled with or otherwise positioned adjacent to opposing edges, corners, or surfaces of the crystal sample (104). As such, once an electric field is generated by the generator (114) and applied to the electrodes (110, 112), the electrodes (110, 112) provide an electric field across a portion or the entire crystal sample (104). In some embodiments, in addition to or in alternative to a heating plate (108), the temperature-controllable heating element can include a laser (109) selectively operable to emit a laser beam onto the crystal (104). The laser (109) may heat up the entire crystal (104) or only a portion of it. Further, the laser (109) may be a continuous wave laser or a pulsed laser.

By placing the crystal sample (104) within the vacuum chamber (106) on the heating stage (108), the crystal sample (104) is protected from damage by the ambient gas during annealing. This provides near-uniform temperature across the crystal sample (104) and prevents electrical breakdown of the ambient gas as well. The heating stage (108) is operable to heat the crystal sample (104) to a temperature where the atomic defects (102) in the crystal sample (104) start to become mobile. This allows for the defects (102) to form or realign into the desired arrangements or directions. An electric field is further applied to the crystal sample (104) along one or multiple of the crystal axes (e.g., for a tetrahedral crystal, axes [x+y+z], [x+y−z], [x−y−z], [x−y+z], where x, y, and z are unit vectors for a cartesian coordinate aligned to the face-centered cubic crystal lattice, etc.) (see, unit vectors x (116), y (118), and z (120)) while the crystal sample (104) is at high temperature. This breaks the degeneracy in the formation energy of the defects (102) in different directions. Subsequently, the directions with lower formation energy become more favorable for the defects (102) and the defects (102) therefore form or realign themselves in those directions.

In some embodiments, the vacuums, temperatures, and electric fields can be various as needed. In one example, the vacuum can range from 1 Torr to 1e-8 Torr, the temperature can range from 600 C to 1200 C. for a diamond, and the electric field can range from 1e3 V/cm to 1e7 V/cm. Furthermore, the vacuum can be replaced by an inert gas such as helium or nitrogen.

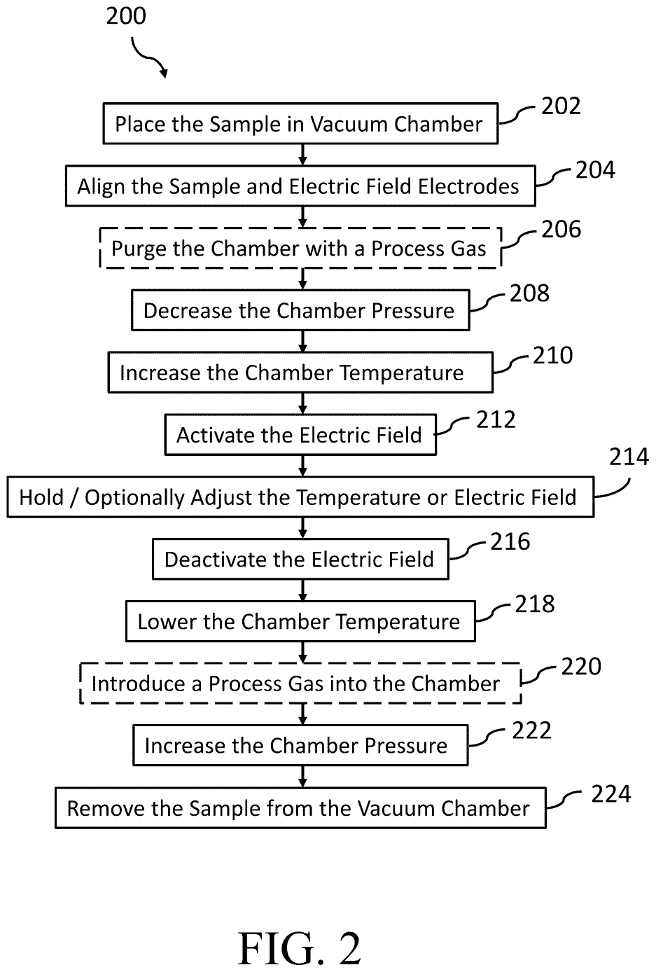

Shown in FIG. 2 is one exemplary method (200) of aligning the atomic defects in a crystal sample. In some embodiments, the method (200) may utilize the system (100) described above. At step (202), the method (200) begins by placing the crystal sample (104) into the vacuum chamber (106), specifically on top of the heating stage (108) as described above. The crystal sample (104) may be, for example, a diamond having one or more defects (102) such as NV centers. At step (204), the electrodes (110, 112) are positioned adjacent to the crystal sample (104) such that an electric field generated by a voltage potential across the electrodes (110, 112) would orient in a desired direction (i.e., along or parallel to a desired axis). Optionally, at step (206), the vacuum chamber (106) may then be purged with a process gas (e.g., nitrogen or argon), which can further reduce the presence of elements that could damage the crystal sample (104) or the heating stage (108) and electrodes (110, 112) at high temperatures. Next, at step (208), the pressure within the vacuum chamber (106) may be pumped down to a desired pressure. In some embodiments, such as for diamonds, the pressure may range from 1 Torr to 1e-8 Torr. At step (210), the temperature within the vacuum chamber (106) may be increased, by heating the heating stage (108), to a desired temperature. In some embodiments, such as for diamonds, the desired temperature may range from 600 C. to 1200 C. Further, in some embodiments, the temperature may be increased gradually through a series of steps. At step (212), the power source (114) may be activated to apply a voltage potential between the electrodes (110, 112), which is operable to align the atomic defects (102) with the direction of the voltage potential. At step (214), a period of time (e.g., 10 minutes to 10 hours, depending on the amplitude and direction of the electric field as well as the temperature) may be allowed to pass, such as to allow the defects (102) time to align. Optionally, the temperature and electric field strength generated within the vacuum chamber (106) may be varied or adjusted during this time, as needed. At step (216), the electric field may be deactivated, and, at step (218), the temperature can be lowered to an ambient or near-ambient temperature. Optionally, at step (220), a process gas may then be introduced into the vacuum chamber (106) (e.g., nitrogen or argon), such as to accelerate the cool-down of the crystal sample (104). Next, at step (222), the pressure within the vacuum chamber (106) may be increased to ambient pressure, which can optionally be accomplished in simultaneously with the lowering of the temperature. Finally, at step (224), the crystal sample (104) may be removed.

The system and method described above provides various improvements over existing technologies, such as those involving PECVD or annealing diamonds in a vacuum chamber. In a PECVD-based technique, diamond is deposited during the process, while the above method does not deposit diamond but only modifies the defects in an existing diamond. PECVD also requires certain combination of gas flows, temperature, and radio frequency (RF) signal to deposit diamond. Moreover, the improved methods do not require any chemicals, but instead only require an electric field. Additionally, annealing a diamond in a vacuum chamber does not involve the use of an electric field, and moreover NV defects created with existing annealing methods are not aligned with each other.

Reference systems that may be used herein can refer generally to various directions (for example, upper, lower, forward and rearward), which are merely offered to assist the reader in understanding the various embodiments of the disclosure and are not to be interpreted as limiting. Other reference systems may be used to describe various embodiments, such as those where directions are referenced to the portions of the device, for example, toward or away from a particular element, or in relations to the structure generally (for example, inwardly or outwardly).

While examples, one or more representative embodiments and specific forms of the disclosure have been illustrated and described in detail in the drawings and foregoing description, the same is to be considered as illustrative and not restrictive or limiting. The description of particular features in one embodiment does not imply that those particular features are necessarily limited to that one embodiment. Some or all of the features of one embodiment can be used in combination with some or all of the features of other embodiments as would be understood by one of ordinary skill in the art, whether or not explicitly described as such. One or more exemplary embodiments have been shown and described, and all changes and modifications that come within the spirit of the disclosure are desired to be protected.

I/We claim:

1. A method for aligning atomic defects in a crystal, comprising:
(a) positioning the crystal within a vacuum chamber;
(b) positioning a pair of electrodes adjacent to the crystal, wherein the positioning of a first electrode of the pair of electrodes relative to a second electrode of the pair of electrodes defines an axis intersecting the first and second electrodes through a portion of the crystal;
(c) decreasing an internal pressure within the vacuum chamber from an ambient pressure to a desired pressure;
(d) increasing an internal temperature within the vacuum chamber from an ambient temperature to a desired temperature;
(e) activating an electric field within the vacuum chamber between the pair of electrodes, wherein the electric field direction is parallel to the axis defined by the pair of electrodes; and
(f) deactivating the electric field.

2. The method of claim 1, further comprising lowering the internal temperature within the vacuum chamber to the ambient temperature upon deactivating the electric field.

3. The method of claim 1, wherein increasing the internal temperature includes activating a heating stage positioned within the vacuum chamber.

4. The method of claim 1, wherein increasing the internal temperature includes activating a laser to emit a beam onto the crystal.

5. The method of claim 1, wherein increasing the internal temperature includes increasing the internal temperature in a plurality of discrete temperature steps.

6. The method of claim 1, wherein the desired temperature ranges from 600 C. to 1200 C.

7. The method of claim 1, wherein the desired pressure ranges between 1 Torr to 1e-8 Torr.

8. The method of claim 1, wherein the crystal includes a diamond having one or more nitrogen-vacancy centers.

9. The method of claim 1, further comprising purging the vacuum chamber with a first process gas prior to decreasing the internal pressure within the vacuum chamber from an ambient pressure to a desired pressure.

10. The method of claim 9, wherein the first process gas includes at least one of nitrogen and argon.

11. The method of claim 1, further comprising increasing the internal pressure within the vacuum chamber to the ambient pressure upon deactivating the electric field.

12. The method of claim 11, further comprising introducing a second process gas into the vacuum chamber prior to increasing the internal pressure within the vacuum chamber to the ambient pressure upon deactivating the electric field.

13. The method of claim 12, wherein the second process gas includes at least one of nitrogen and argon.

14. A method for aligning atomic defects in a crystal, comprising:
(a) positioning the crystal within a vacuum chamber;
(b) positioning a pair of electrodes adjacent to the crystal, wherein the positioning of a first electrode of the pair of electrodes relative to a second electrode of the pair of electrodes defines an axis intersecting the first and second electrodes through a portion of the crystal;
(c) decreasing an internal pressure within the vacuum chamber from a first pressure to a second pressure, wherein the second pressure is less than the first pressure, wherein the second pressure ranges from 1 Torr to 1e-8 Torr;
(d) increasing an internal temperature within the vacuum chamber from a first temperature to a second temperature, wherein the second temperature is greater than the first temperature, wherein the second temperature ranges from 600 C. to 1200 C.; and
(e) activating an electric field within the vacuum chamber between the pair of electrodes to align the atomic defects in the crystal, wherein the electric field direction is parallel to the axis defined by the pair of electrodes.

15. The method of claim 14, wherein the crystal includes a diamond having one or more nitrogen-vacancy centers.

16. The method of claim 14, further comprising deactivating the electric field upon aligning the atomic defects in the crystal.

17. The method of claim 16, comprising:
upon deactivating the electric field, lowering the internal temperature within the vacuum chamber to the first temperature and increasing the internal pressure within the vacuum chamber to the first pressure.

18. A method for aligning atomic defects in a crystal, comprising:
(a) positioning the crystal within a vacuum chamber, wherein the crystal includes a diamond having one or more nitrogen-vacancy centers;
(b) positioning a pair of electrodes adjacent to the crystal, wherein the positioning of a first electrode of the pair of electrodes relative to a second electrode of the pair of electrodes defines an axis intersecting the first and second electrodes through a portion of the crystal;
(c) purging the vacuum chamber with a first process gas;
(d) decreasing an internal pressure within the vacuum chamber from an ambient pressure to a desired pressure;
(e) increasing an internal temperature within the vacuum chamber from an ambient temperature to a desired temperature;
(f) activating an electric field within the vacuum chamber between the pair of electrodes, wherein the electric field direction is parallel to the axis defined by the pair of electrodes;
(g) introducing a second process gas into the vacuum chamber; and
(h) deactivating the electric field.

19. The method of claim 18, wherein the first process gas includes at least one of nitrogen and argon. The method of claim 18, wherein the second process gas includes at least one of nitrogen and argon.
